(19) United States
(12) Patent Application Publication
(10) Pub. No.: US 2017/0018415 A1
(43) Pub. Date: Jan. 19, 2017

(54) DIVIDED-APERTURE LASER DIFFERENTIAL CONFOCAL LIBS AND RAMAN SPECTRUM-MASS SPECTRUM MICROSCOPIC IMAGING METHOD AND DEVICE

(71) Applicant: Beijing Institute of Technology, Beijing (CN)

(72) Inventors: Weiqian ZHAO, Beijing (CN); Yun WANG, Beijing (CN); Lirong QIU, Beijing (CN)

(73) Assignee: Beijing Institute of Technology, Beijing (CN)

(21) Appl. No.: 15/208,633

(22) Filed: Jul. 13, 2016

(30) Foreign Application Priority Data
Jul. 17, 2015 (CN) 2015104234224

(51) Int. Cl. H01J 49/02; H01J 49/00; G01J 3/44; H01J 49/16; G01J 3/443

(52) U.S. Cl. CPC H01J 49/025; H01J 49/164; G01J 3/443; G01J 3/4412; H01J 49/0004

(57) ABSTRACT

The present disclosure relates to a divided-aperture laser differential confocal LIBS and Raman spectrum-mass spectrum microscopic imaging method and device. In the present disclosure, the divided-aperture differential confocal imaging technology is combined with the spectrum technology and the mass spectrum detecting technology, high-spatial resolution form imaging is performed on a sample by utilizing a minute focusing spot of a divided-aperture differential confocal microscope processed by using the super-resolution technique, a mass spectrum detection is performed on charged molecules or atoms in a sample microzone by using a mass spectrum detecting system, a microzone spectrum detection is performed on spectrum excited by the focusing spot of a divided-aperture differential confocal microscope system by using a spectrum detecting system, and high-spatial resolution and high-sensitivity imaging and detection of complete composition information and form parameter of the sample microzone are implemented by using complementary advantages and structural fusion in laser multi-spectrum detection.

### CROSS-REFERENCE TO RELATED APPLICATIONS

This application is based upon and claims priority to Chinese Patent Applications No. CN201510423422.4, filed Jul. 17, 2015, the entire contents of which are incorporated herein by reference.

### TECHNICAL FIELD

The present disclosure belongs to the field of confocal microscopic imaging technology, spectrum imaging technology and mass spectrum imaging technology, combines divided-aperture differential confocal microscopic imaging technology, laser-induced breakdown spectroscopy imaging technology. Raman spectrum imaging technology and mass. spectrum imaging technology, relates to a divided-aperture laser differential confocal TABS and Raman spectrum-mass spectrum microscopic imaging method and device, and has wide application prospect in the fields of biology, materials, minerals and micro-nano manufacture technologies, etc.

### BACKGROUND

Mass Spectrometry is an instrument showing image spectrums, in which charged atoms, molecules or molecular fragments with various specific charge, generated from sample components' ionizing by focusing separately under actions of electric and magnetic fields and put in the order of mass-to-charge ratio quantities. Mass spectrum imaging is to make mass spectrum analysis of a plurality of micro-areas in the sample's 2-d area separately in order to detect/test the distribution of mass with specialized mass-to-charge ratio (m/z).

Since the mid of the 80s of last century, there appeared the biomass spectrum imaging technology of matrix-assisted laser desorption/ionization with high sensibility and high quality detection sphere, which has opened up a brand-new sphere of mass spectra theory—biomass spectrum, spurs to expand mass spectrum technology applying in the study spheres of life science, esp. applications of mass spectrum in analysis of protein, nucleic acid, glycoprotein, and so on. The technology provides new means for life science study, but also promotes mass spectrum technology self's development.

Yet there exist the following distinct problems in the present matrix-assisted laser desorption/ionization mass spectrum instrument.

1) There still exist such problems, as laser focusing spot being bigger, spatial resolving power in mass spectrum detecting not higher, and so on, because of utilizing simple laser focusing to desorption/ionization sample;

2) No way to detect neutral atom, molecule, mid-ion, radical group and others, which results in restricting to accurately and completely obtain the information on sample components; and

3) Longer time is spent for mass spectrum imaging, and in laser mass spectrometry, the axial position of its focusing spot, relative to the detected sample, often occurs drifting.

It is of utmost important meanings for scientific study and productive detection to accurately obtain morphology of “micro-area” and complete information on components of mineral products, space mass and bio-sample. As a matter of fact, at present, in the fields of mineral product's analysis, biochemical detection, how to high-sensitively detect information on components in micro-areas is an important technical problem demanding prompt study and solution.

Strong pulse laser from the laser induced breakdown spectrum (LIBS), focused on sample's surface may make the sample ionized, thus may arouse the sample to produce plasma. By detecting radiated spectrum of energy decay of the plasma, it is able to obtain the information on sample's composition of atoms and small molecules of elements. By utilizing Raman laser spectrum it may detect sample's molecular excitation spectrum and get the information on its chemical bonds and molecular structure in the sample. By Raman laser spectrum technology combining with LIBS and with mass spectrum detecting technology, it may be realized for their advantages to complement mutually, as well as for their structural functions to merge. By utilizing laser multi-spectrum (mass spectrum, Raman spectrum and LIBS) emerging technology, to detect sample's complete composition information may be realized.

The divided-aperture laser differential confocal technology applies non-common-path structure of lighting and detecting-light-path to detect, which not only obviously enhances light-path axial resolving power and focusing accuracy, and realizes high-resolution imaging detection of sample's morphology, but may also effectively inhibit backward scattering disturbance to heighten signal to noise ratio of the spectrum detection.

On the basis above, the invention provides a microscopic imaging method and device, utilizing divided-aperture laser differential confocal LIBS, Raman spectrum-mass spectrum technologies, the innovation of which lies in, for the first time, its having merged the technologies of divided-aperture differential confocal microscope, laser Raman spectrum, LIBS and mass spectrum detecting, with high-spatial resolving power. It may realize to make imaging and detecting the morphology and composition within detected sample's micro-areas, with high spatial resolution and top-sensitivity as well.

The invention, a microscopic imaging method and device with high spatial resolution LIBS Raman spectrum and mass spectrum, may provide an up-dated effective technical way for imaging and detecting morphology and composition in the fields of biology, materials, physical chemistry, micro-nano manufacturing, etc.

### SUMMARY

To improve spatial resolving power of mass spectrum imaging and inhibit drift of a focusing spot relative to a sample in an imaging process, the present disclosure proposes a divided-aperture laser differential confocal LIBS and Raman spectrum-mass spectrum microscopic imaging method and device to simultaneously obtain microzone form information and composition information of a measured object. In the present disclosure, a detection function and a laser focusing desorption ionization function of a focusing spot of a laser divided-aperture differential confocal microscope are fused, high-spatial resolution form imaging is performed on a sample by utilizing a minute focusing spot of the divided-aperture differential confocal microscope obtained by utilizing super-resolution technique, a detection is performed on Raman spectrum generated by a sample excited by the focusing spot of the divided-aperture confocal microscope system by using a Raman spectrum detecting system, a microzone mass spectrum imaging is performed on charged molecules or atoms generated by means of desorption ionization of the sample by the focusing spot of the divided-aperture differential confocal microscope system by using a mass spectrum detecting system, a laser-induced breakdown spectrum imaging is performed on plasma emission spectrum information generated by means of desorption ionization of the sample by the focusing spot of the divided-aperture differential confocal microscope system by using a laser-induced breakdown spectrum detecting system, then completed sample composition information is obtained through fusion and comparison of detected data information, and then imaging and detection of high-spatial resolution and high-sensitivity form and composition of a measured sample microzone are implemented.

The object of the invention is achieved by the technical solutions hereinbelow.

A divided-aperture laser differential confocal LIBS and Raman spectrum-mass spectrum microscopic imaging method is disclosed in an embodiment of the present disclosure, axial focus fixing and imaging are performed on a sample by utilizing a focusing spot of a high-spatial resolution divided-aperture differential confocal microscope system, a detection is performed on Raman spectrum generated by a sample excited by the focusing spot of the divided-aperture differential confocal microscope system by using a Raman spectrum detecting system, a microzone mass spectrum imaging is performed on charged molecules or atoms generated by means of desorption ionization of the sample by the focusing spot of the divided-aperture differential confocal microscope system by using a mass spectrum detecting system, a detection is performed on plasma emission spectrum generated by means of desorption ionization of the sample by the focusing spot of the divided-aperture differential confocal microscope system by using a laser-induced breakdown spectrum detecting system, and then imaging and detection of high-spatial resolution and high-sensitivity form and composition of a measured sample microzone are implemented through fusion and comparison analysis of detected data information, comprising following steps:

step I: a parallel beam being focused on a measured sample by a compression focusing spot system and a D-type lighting pupil in a D-type lighting collection lens that are arranged along a direction of an incident optical axis;

step II: a computer controlling a three-dimensional workbench to drive the measured sample to move up and down nearby a focal point of the D-type lighting collection lens along a direction of a measurement surface normal, performing a partition detection on amplification Airy disk by using a D-type collection pupil and a beam splitter that are arranged along a direction of a collecting optical axis, a dichroic beam splitter in a reflection direction of the beam splitter and a collection lens positioned in a reflection direction of the dichroic beam splitter, a relay amplifying lens, and a first light intensity point detector and a second light intensity point detector that are positioned on a focal plane of the relay amplifying lens and symmetrically arranged with respect to the collecting optical axis to obtain intensity characteristic curves of an Airy disk first microzone and an Airy disk second microzone, namely a first off-axis confocal axial intensity curve and a second off-axis confocal axial intensity curve respectively;

step III: obtaining a divided-aperture differential confocal axial intensity curve by performing a subtraction processing on the first off-axis confocal axial intensity curve and the second off-axis confocal axial intensity curve, wherein the divided-aperture differential confocal axial intensity curve may be utilized to accurately position axial height information of the measured sample;

step IV: the computer controlling, according to a zero point position z_{A} value of the divided-aperture differential confocal axial intensity curve, the three-dimensional workbench to drive the measured sample to move along the direction of the measurement surface normal, so that a focusing spot of the D-type lighting collection lens is focused on the measured sample;

step V: performing a detection on Raman spectrum that is reflected by the beam splitter, transmitted by the dichroic beam splitter and collected by a Raman spectrum collection lens by utilizing a Raman spectrum detecting system, and measuring sample chemical bond and molecular structure information of the measured sample corresponding to a focusing spot area;

step VI: changing a lighting mode of the parallel beam, and exciting microzone desorption ionization of the measured sample to generate plasma plume;

step VII: utilizing an ionization sample suction pipe to suck molecules, atoms and ions in the plasma plume generated by desorption ionization of the measured sample by the focusing spot into a mass spectrum detecting system to perform mass spectrum imaging, and measuring mass spectrum information corresponding to the focusing spot area;

step VIII: performing a detection on laser-induced breakdown spectrum that is transmitted by the beam splitter and collected by a laser-induced breakdown spectrum collection lens by utilizing a laser-induced breakdown spectrum detecting system, and measuring sample element composition information corresponding to the focusing spot area;

step IX: the computer performing fusion processing on sample height information from laser focusing spot measured by a laser divided-aperture differential confocal detecting system. Raman spectrum of laser focusing microzone detected by a laser Raman spectrum detecting system, laser-induced breakdown spectrum of laser focusing microzone detected by the laser-induced breakdown spectrum detecting system, and mass spectrum information of laser focusing microzone measured by the mass spectrum detecting system, and then obtaining height and mass spectrum information of a focusing spot microzone;

step X: the computer controlling the three-dimensional workbench to make the focal point of the D-type lighting collection lens align to a next to-be-measured area of the measured sample, and then operating according to step II˜step IX to obtain height, spectrum and mass spectrum information of a next to-be-measured focus area; and

step XI: repeating step X until all to-be-measured points on the measured sample are measured, and then utilizing the computer to manage to obtain form information and complete composition information of the measured sample.

In the embodiment of the present disclosure, there is included that: the parallel beam being reshaped into an annular beam by a vector beam generating system and a pupil filter that are arranged along a direction of an incident optical axis, and the annular beam being focused on the measured sample by a circular lighting collection lens to generate the plasma plume by means of desorption ionization.

In the embodiment of the present disclosure, there is included that: lighting collection functions of the D-type lighting pupil and the D-type collection pupil in the D-type lighting collection lens may be achieved by means of a circular lighting pupil and a circular collection pupil in the circular lighting collection lens.

A divided-aperture laser differential confocal LMS and Raman spectrum-mass spectrum microscopic imaging device is disclosed in the embodiment of the present disclosure, comprising: a point light source, and a collimating lens, a compression focusing spot system and a D-type lighting pupil of a D-type lighting collection lens focusing a spot to a measured sample that are arranged in a direction of an incident optical axis; comprising: a D-type collection pupil of the D-type lighting collection lens and a beam splitter that are arranged along a direction of a collecting optical axis, and a dichroic beam splitter positioned in a reflection direction of the beam splitter, a collection lens and a relay amplifying lens positioned in a reflection direction of the dichroic beam splitter, and a first light intensity point detector and a second light intensity point detector that are positioned on a focal plane of the relay amplifying lens and symmetrically arranged with respect to the light axis, and further comprising: a Raman spectrum collection lens positioned in a transmission direction of the dichroic beam splitter and configured to detect Raman spectrum, and a Raman spectrum detecting system positioned at a focal point of the Raman spectrum collection lens; a laser-induced breakdown spectrum collection lens and a laser-induced breakdown spectrum detecting system that are positioned in a transmission direction of the beam splitter and configured to detect laser-induced breakdown spectrum, and an ionization sample suction pipe used for desorption ionization of plasma plume composition by a focusing spot of the D-type lighting collection lens and a mass spectrum detecting system, wherein the incident optical axis and the collecting optical axis have an included angle of 2α therebetween and are symmetrical with respect to a measurement surface normal.

In the embodiment of the present. disclosure, there is included that: the compression focusing spot system may be substituted by a vector beam generating system configured to generate a vector beam and a pupil filter that are arranged along the direction of an incident, optical axis.

In the embodiment of the present disclosure, there is included that: the D-type lighting collection lens may be substituted by a circular lighting collection lens.

In the embodiment of the present disclosure, there is included that: the first light intensity point detector and the second light intensity point detector may be substituted by a CCD detector.

The beneficial effect of this application:

Compared with the prior art, the present disclosure has following advantages:

1) Divided-aperture differential confocal microscopic technique having high-spatial resolving power is fused with mass spectrum detecting technology, so that a light spot of a divided-aperture differential confocal microscopic imaging system implements double functions of focusing detection and sample desorption ionization, thereby implementing high-spatial mass spectrum microscopic imaging of sample microzone mass spectrum.

2) In combination with detection of Raman spectrum and laser-induced breakdown spectrum, it is overcome disadvantages of unavailable detection of neutral atoms, molecules, ions and groups or the like by an existing laser mass spectrometry, and it is implemented complementary advantages and structural function fusion in laser multi-spectrum (mass spectrum, Raman spectrum and laser-induced breakdown spectrum) composition imaging detection, thereby obtaining more comprehensive microzone composition information.

3) Focus pre-determining of a sample is performed by utilizing a zero crossing point of a divided-aperture differential confocal curve, so that a minimum focusing spot is focused onto a surface of the sample, thereby implementing sample microzone high-spatial resolution mass spectrum detection and microzone microscopic imaging and effectively fulfilling potential of a divided-aperture differential confocal system in resolution.

4) By performing focus pre-determining of the sample by utilizing the zero crossing point of the divided-aperture differential confocal curve, it is inhibited a problem of drifting of the focusing spot of the mass spectrometry compared to the measured sample due to long-time mass spectrum imaging.

5) By using compression focusing spot technology, spatial resolving power of the laser mass spectrometry is improved.

6) By using divided-aperture structural beam oblique incidence detection, it is overcome the defect that an existing confocal microscopic imaging technology is unable to inhibit interference of stray light on the focal plane, and thus the resistance to stray light is strong.

### BRIEF DESCRIPTION OF THE DRAWINGS

FIG. 1 is a schematic diagram of a divided-aperture laser differential confocal LIBS and Raman spectrum-mass spectrum microscopic imaging method;

FIG. 2 is a diagram of a divided-aperture laser differential confocal LIBS and Raman spectrum-mass spectrum microscopic imaging method and device according to Embodiment 1; and

FIG. 3 is a diagram of a divided-aperture laser differential confocal LIBS and Raman spectrum-mass spectrum microscopic imaging method and device according to Embodiment 2; in which

1—point light source, 2—collimating lens, 3—parallel beam, 4—compression focusing spot system, 5—D-type lighting collection lens, 6—D-type lighting pupil, 7—D-type collection pupil, 8—incident optical axis, 9—measured sample, 10—measurement surface normal, 11—plasma plume, 12—collecting optical axis, 13—collection lens, 14—relay amplifying lens, 15—focal plane, 16—amplification Airy disk, 17—first light intensity point detector, 18—second light intensity point detector, 19—Airy disk first microzone, 20—Airy disk second microzone, 21—first off-axis confocal axial intensity curve, 22—second off-axis confocal axial intensity curve, 23—differential confocal axial intensity curve, 24—computer, 25—three-dimensional workbench, 26—ionization sample suction pipe, 27—mass spectrum detecting system, 28—beam splitter, 29—laser-induced breakdown spectrum collection lens, 30—laser-induced breakdown spectrum detecting system, 31—vector beam generating system, 32—pupil filter, 33—circular lighting collection lens, 34—circular lighting pupil, 35—circular collection pupil, 36—CCD detector, 37—outgoing beam attenuator, 38—detection beam attenuator, 39—pulsed laser, 40—condenser lens, 41—light transmission optical fiber, 42—laser-induced breakdown spectrum, 43—dichroic beam splitter, 44—Raman spectrum, 45—Raman spectrum collection lens, 46—Raman spectrum detecting system.

### DESCRIPTION OF THE EMBODIMENTS

The following further describes the present disclosure with reference to the accompanying drawings and embodiments.

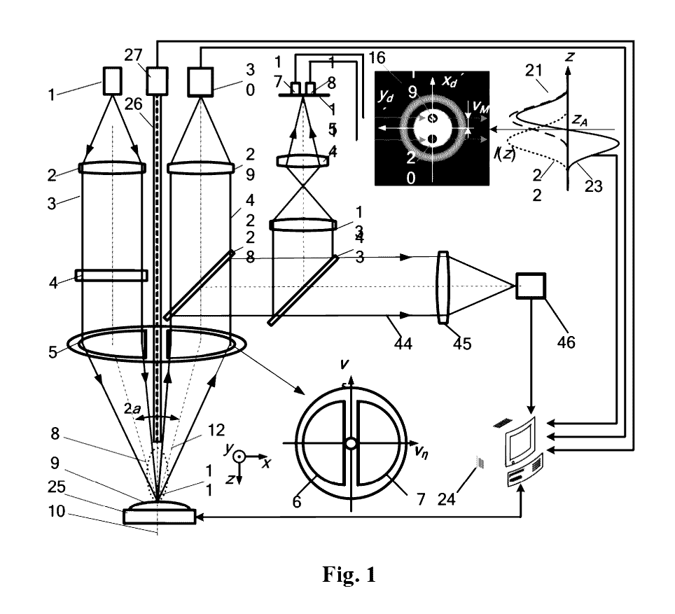

A core method of the present disclosure is as shown in FIG. 1, where an annular light transverse super-resolution system consisting of a compression focusing spot system 4 and a D-type lighting pupil 6 of a D-type lighting collection lens 5 is configured to compress a lateral dimension of a focusing spot.

All following embodiments are implemented on a basis of FIG. 1.

### Embodiment 1

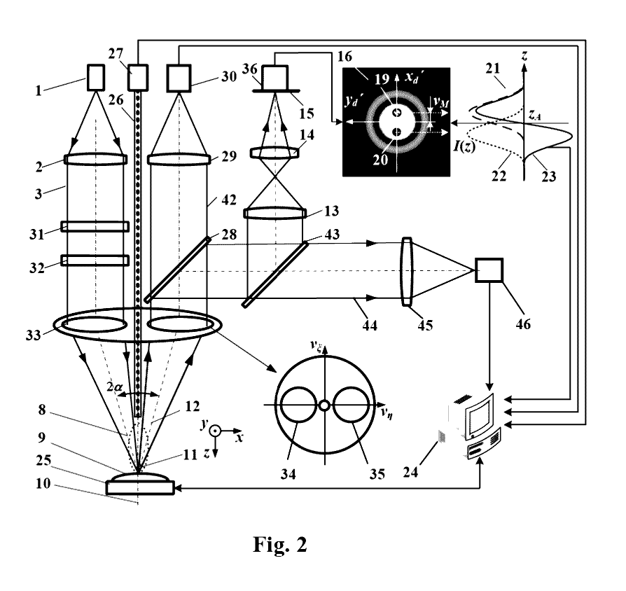

In the divided-aperture laser differential confocal LIBS and Raman spectrum-mass spectrum microscopic imaging device as shown in FIG. 2, the compression focusing spot system 4 may be substituted by a vector beam generating system 31 and a pupil filter 32, the D-type lighting collection lens 5 may be substituted by a circular lighting collection lens 33, and a first light intensity point detector 17 and a second light intensity^{.} point detector 18 may be substituted by a CCD detector 36.

The divided-aperture laser differential confocal LIDS and Raman spectrum-mass spectrum microscopic imaging device as shown in FIG. 2 includes: a point light source 1, and a collimating lens 2, the vector beam generating system 31, the pupil filter 32 and a circular lighting pupil 34 of a circular lighting collection lens 33 focusing a spot to a measured sample 9 that are arranged in a direction of an incident optical axis 8, and further includes: a circular collection pupil 35 of the circular lighting collection lens 33, a beam splitter 28 positioned in a direction of a collecting optical axis 12, a dichroic beam splitter 43 positioned in a reflection direction of the beam splitter 28 and a collection lens 13, a relay amplifying lens 14 and a CCD detector 36 positioned on a focal plane 15 of the relay amplifying lens 14 that are arranged in a reflection direction of the dichroic beam splitter 43, and an ionization sample suction pipe 26 used for desorption ionization of plasma plume 11 composition by a focusing spot of the circular lighting collection lens 33 and a mass spectrum detecting system 27, where the incident optical axis 8 and the collecting optical axis 12 have an included angle of 2α therebetween and are symmetrical with respect to a measurement surface normal 10.

Functions of main, compositions are as below.

A laser focusing system consisting of the point light source 1, and the collimating lens 2, the vector beam generating system 31, the pupil filter 32 and the circular lighting pupil 34 of the circular lighting collection lens 33 focusing a spot to the measured sample 9 that are arranged in the direction of the incident optical axis 8 is configured to generate a minute focusing spot beyond a diffraction limit, where the super-diffraction minute spot has double functions of measuring the sample surface and generating surface plasma.

The laser divided-aperture differential confocal detecting system consisting of the circular collection pupil 35 of the circular lighting collection lens 33 and the beam splitter 28 that are arranged along the direction of the collecting optical axis 12, the dichroic beam splitter 43 positioned in the reflection direction of the beam splitter 28 and the collection lens 13, the relay amplifying lens 14 and the CCD detector 36 positioned on the focal plane 15 of the relay amplifying lens 14 that are positioned in the reflection direction of the dichroic beam splitter 43 performs precise focus fixing on the measured sample 9, performs axial positioning on a spot location focused by the circular lighting collection lens 33 to the measured sample 9, and measures a sample height corresponding to the location of the focusing spot.

The Raman spectrum detecting system consisting of the circular collection pupil 35 of the circular lighting collection lens 33 and the beam splitter 28 that are arranged along the direction of the collecting optical axis 12, the dichroic beam splitter 43, the Raman spectrum collection lens 45 and the Raman spectrum detecting system 46 positioned at the focal spot of the Raman spectrum collection lens 45 that are arranged in the reflection direction of the beam splitter 28 is configured to detect Raman spectrum 44 of the measured sample 9, and measures molecular structure and chemical bond information of sample corresponding to a focusing spot area.

The mass spectrum detecting system consisting of the ionization sample suction pipe 26 and the mass spectrum detecting system 27 performs flight time mass spectrum detection based on charged atoms and molecules in the plasma plume 11 detected by using Time of Flight (TOF).

The laser-induced breakdown spectrum detecting system consisting of the collection lens 13 and the beam splitter 28 that are arranged along the collecting optical axis 12, the laser-induced breakdown spectrum collection lens 29 positioned in the transmission direction of the beam splitter 28 and laser-induced breakdown spectrum detecting system 30 positioned at the focal spot of the laser-induced breakdown spectrum collection lens 29 is configured to detect laser-induced breakdown spectrum 42 of the measured sample 9, and measures sample element composition information corresponding to the focusing spot area.

A radial polarized light longitudinal tight focusing system consisting of the vector beam generating system 31, the pupil filter 32 and the circular lighting pupil 34 of the circular lighting collection lens 33 is configured to compress the lateral dimension of the focusing spot.

A three-dimensional moving system consisting of the computer 24 and the three-dimensional workbench 25 may perform axial focus fixing and three-dimensional scanning on the measured sample 9.

The process of high resolution mass spectrum imaging of the measured sample mainly includes following steps:

step I: a light beam emitted from the point light source 1 is collimated by the collimating lens 2 into a parallel beam 3, the parallel beam 3 generates an annular beam through the vector beam generating system 31 and the pupil filter 32, and the annular beam is focused by the circular lighting pupil 34 of the circular lighting collection lens 33 into a minute spot beyond the diffraction limit that is irradiated onto the measured sample 9;

step II: the computer 24 is employed to control the three-dimensional workbench 25 to drive the laser divided-aperture differential confocal detecting system consisting of the circular collection pupil 35, the relay amplifying lens 14 and the CCD detector 36 positioned on the focal plane 15 of the relay amplifying lens 14 to perform axial scanning on the measured sample 9, and perform divided detection on amplification Airy disk 16 to obtain intensity characteristic curves of an Airy disk first microzone 19 and an Airy disk second microzone 20, namely a first off-axis confocal axial intensity curve 21 and a second off-axis confocal axial intensity curve 22 respectively;

step III: it is obtained a divided-aperture differential confocal axial intensity curve 23 by performing a subtraction processing on the first off-axis confocal axial intensity curve 21 and the second off-axis confocal axial intensity curve 22, and the divided-aperture differential confocal axial intensity curve 23 may be utilized to accurately position axial height information of the measured sample 9;

step IV: the computer 24 controls, according to a zero point position z_{A} value of the divided-aperture differential confocal axial intensity curve 23, the three-dimensional workbench 25 to drive the measured sample 9 to move along the direction of the measurement surface normal 10, so that the focusing spot of the circular lighting collection lens 33 is focused on the measured sample 9, thereby implementing an initial focus fixing of the measured sample 9;

step V: it is performed a detection on Raman spectrum 44 that is reflected by the beam splitter 28, transmitted by the dichroic beam splitter 43 and collected by a Raman spectrum collection lens 45 by utilizing a Raman spectrum detecting system 46, and it is measured sample chemical bond and molecular structure information corresponding to a focusing spot area;

step VI: it is changed a working mode of the point light source 1 to improve illumination intensity, and it is excited microzone desorption ionization of the measured sample 9 to generate a plasma plume 11;

step VII: an ionization sample suction pipe 26 is utilized to suck molecules, atoms and ions in the plasma plume 11 generated by desorption ionization of the measured sample 9 by the focusing spot into a mass spectrum detecting system 27 to perform mass spectrum imaging, and it is measured mass spectrum information corresponding to the focusing spot area;

step VIII: it is performed a detection on laser-induced breakdown spectrum 42 that is transmitted by the beam splitter 28 and collected by a laser-induced breakdown spectrum collecting lens 29 by utilizing a laser-induced breakdown spectrum detecting system 30, and it is measured sample element composition information corresponding to the focusing spot area;

step IX: the computer 24 performs fusion processing on laser focusing microzone form information measured by a laser divided-aperture confocal detecting system, laser focusing microzone Raman spectrum 44 detected by a Raman spectrum detecting system 46, laser focusing microzone laser-induced breakdown spectrum information detected by the laser-induced breakdown spectrum detecting system 30, and laser focusing microzone mass spectrum information measured by the mass spectrum detecting system 27 to obtain height, spectrum and mass spectrum information corresponding to the focusing spot area;

step X: the computer 24 controls the three-dimensional workbench 25 to make the circular lighting collection lens 33 align to a next to-be-measured area of the measured sample, and then operates according to step II˜step IX to obtain height, spectrum and mass spectrum information corresponding to a next to-be-measured focus area; and

step XI: step X is repeated until all to-be-measured points on the measured sample 9 are measured, and then the computer 24 is utilized to perform data fusion and image reconstruction to obtain form information and complete composition information of the measured sample.

### Embodiment 2

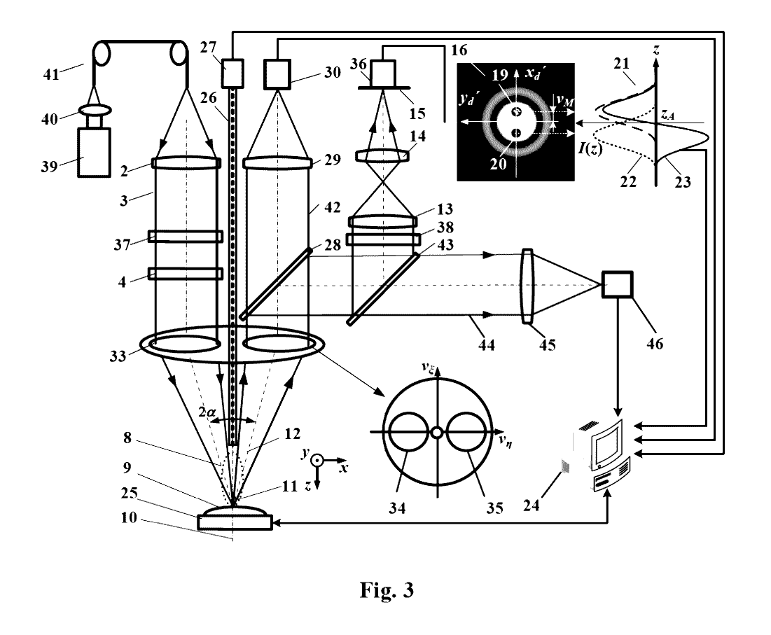

In the divided-aperture laser differential confocal LIBS and Raman spectrum-mass spectrum microscopic imaging device as shown in FIG. 3, the point light source 1 may be substituted by a pulsed laser 39, a condenser lens 40, and light transmission optical fiber 41 at the focal point of the condenser lens 40. The D-type lighting collection lens 5 may be substituted by the circular lighting collection lens 33. The first light intensity point detector 17 and the second light intensity point detector 18 may be substituted by the CCD detector 36. An outgoing beam attenuator 37 is introduced in the laser focusing system, and a detection beam attenuator 38 is introduced in the laser divided-aperture differential confocal detecting system.

The outgoing beam attenuator 37 and the detection beam attenuator 38 constitute a light intensity adjusting system, which is configured to attenuate intensity of the focusing spot and light spot detected by the CCD detector 36 so as to adapt to requirements for intensity of light during sample surface positioning.

The process of high resolution mass spectrum imaging of the measured sample mainly includes following steps:

step II in Embodiment 1: the computer 24 is employed to control the three-dimensional workbench 25 to drive the laser divided-aperture differential confocal detecting system consisting of the circular collection pupil 35, the relay amplifying lens 14 and the CCD detector 36 positioned on the focal plane 15 of the relay amplifying lens 14 performing axial scanning on the measured sample 9, and performing divided detection on amplification Airy 16 disk to obtain intensity characteristic curves of the Airy disk first microzone 19 and the Airy disk second microzone 20, namely the first off-axis confocal axial intensity curve 21 and the second off-axis confocal axial intensity curve 22 respectively; and the detection beam attenuator 38 is adjusted to attenuate intensity of light so as to avoid oversaturation detection by the CCD detector 36;

step VI: it is changed the working mode of the pulsed laser 39, the outgoing beam attenuator 37 is adjusted to increase focusing spot intensity of the circular lighting collection lens 33, and it is excited microzone desorption ionization of the measured sample 9 to generate the plasma plume 11; and

the other image methods and processes are alike to Embodiment 1.

Descriptions of the embodiments are made with reference to the accompanying drawings in the above; however these descriptions should not be construed as limiting the scope of the present disclosure.

The scope of protection of the present disclosure is limited by appended claims, and any modification on a basis of the claims of the present disclosure shall fall within the scope of protection of the present disclosure.

What is clamed is:

1. A divided-aperture laser differential confocal LIBS and Raman spectrum-mass spectrum microscopic imaging method, wherein: axial focus fixing and imaging are performed on a sample by utilizing a focusing spot of a high-spatial resolution divided-aperture differential confocal microscope system, a detection is performed on Raman spectrum generated by a sample excited by the focusing, spot of the divided-aperture differential confocal microscope system by using a Raman spectrum detecting system, a microzone mass spectrum imaging is performed on charged molecules or atoms generated by means of desorption ionization of the sample by the focusing spot of the divided-aperture differential confocal microscope system by using a mass spectrum detecting system, a detection is performed on plasma emission spectrum generated by means of desorption ionization of the sample by the focusing spot of the divided-aperture differential confocal microscope system by using a laser-induced breakdown spectrum detecting system, and then imaging and detection of high-spatial resolution and high-sensitivity form and composition of a measured sample microzone are implemented through fusion and comparison analysis of detected data information, comprising following steps:
step I: a parallel beam being focused on a measured sample by a compression focusing spot system and a D-type lighting pupil (6) in a D-type lighting collection lens that are arranged along a direction of an incident optical axis;
step II: a computer controlling a three-dimensional workbench to drive the measured sample to move up and down nearby a focal point, of the D-type lighting collection lens along a direction of a measurement surface normal, performing a partition detection on amplification Airy disk by using a D-type collection pupil and a beam splitter that are arranged along a direction of a collecting optical axis, a dichroic beam splitter in a reflection direction of the beam splitter and a collection lens positioned in a reflection direction of the dichroic beam splitter, a relay amplifying lens, and a first light intensity point detector and a second light intensity point detector that are positioned on a focal plane of the relay amplifying lens and symmetrically arranged with respect to the collecting optical axis to obtain intensity characteristic curves of an Airy disk first microzone and an Airy disk second microzone, namely a first off-axis confocal axial intensity curve and a second off-axis confocal axial intensity curve respectively;
step III: obtaining a divided-aperture differential confocal axial intensity curve by performing a subtraction processing on the first off-axis confocal axial intensity curve and the second off-axis confocal axial intensity curve, wherein the divided-aperture differential confocal axial intensity curve may be utilized to accurately position axial height information of the measured sample;
step IV: the computer controlling, according to a zero point position z_{A} value of the divided-aperture differential confocal axial intensity curve, the three-dimensional workbench to drive the measured sample to move along the direction of the measurement surface normal, so that a focusing spot of the D-type lighting collection lens is focused on the measured sample;
step V: performing a detection on Raman spectrum that is reflected by the beam splitter, transmitted by the dichroic beam splitter and collected by a Raman spectrum collection lens by utilizing a Raman spectrum detecting system, and measuring sample chemical bond and molecular structure information of the measured sample corresponding to a focusing spot area;
step VI: changing a lighting mode of the parallel beam, and exciting microzone desorption ionization of the measured sample to generate plasma plume;
step VII: utilizing an ionization sample suction pipe to suck molecules, atoms and ions in the plasma plume generated by desorption ionization of the measured sample by the focusing spot into a mass spectrum detecting system to perform mass spectrum imaging. and measuring mass spectrum information corresponding to the focusing spot area;
step VIII: performing a detection on laser-induced breakdown spectrum that is transmitted by the beam splitter and collected by a laser-induced breakdown spectrum collection lens by utilizing a laser-induced breakdown spectrum detecting system, and measuring sample element composition information corresponding to the focusing spot area;
step IX: the computer performing fusion processing on sample height information from laser focusing spot measured by a laser divided-aperture differential confocal detecting system. Raman spectrum of laser focusing microzone detected by a laser Raman spectrum detecting system, laser-induced breakdown spectrum of laser focusing microzone detected by the laser-induced breakdown spectrum detecting system, and mass spectrum information of laser focusing microzone measured by the mass spectrum detecting system, and then obtaining height and mass spectrum information of a focusing spot microzone;
step X: the computer controlling the three-dimensional workbench to make the focal point of the D-type lighting collection lens align to a next to-be-measured area of the measured sample, and then operating according to step II˜step IX to obtain height, spectrum and mass spectrum information of a next to-be-measured focus area; and
Step XI: repeating step X until all to-be-measured points on the measured sample are measured, and then utilizing the computer to manage to obtain form information and complete composition information of the measured sample.

2. The divided-aperture laser differential confocal LIBS and Raman spectrum-mass spectrum microscopic imaging method according to claim 1, wherein step I may comprise:
the parallel beam being reshaped into an annular beam by a vector beam generating system and a pupil filter that are arranged along a direction of an incident optical axis, and the annular beam being focused on the measured sample by a circular lighting collection lens to generate the plasma plume by means of desorption ionization.

3. The divided-aperture laser differential confocal LIBS and Raman spectrum-mass spectrum microscopic imaging method according to claim 1, wherein: lighting collection functions of the D-type lighting pupil and the D-type collection pupil in the D-type lighting collection lens may be achieved by means of a circular lighting pupil and a circular collection pupil in the circular lighting collection lens.

4. A divided-aperture laser differential confocal LIBS and Raman spectrum-mass spectrum microscopic imaging device, wherein a point light source, and a collimating lens, a compression focusing spot system and a D-type lighting pupil of a D-type lighting collection lens focusing a spot to a measured sample that are arranged in a direction of an incident optical axis; comprising: a D-type collection pupil of the D-type lighting collection lens and a beam splitter that are arranged along a direction of a collecting optical axis, and a dichroic beam splitter positioned in a reflection direction of the beam splitter, a collection lens and a relay amplifying lens positioned in a reflection direction of th dichroic beam splitter, and a first light intensity point detector and a second light intensity point detector that are positioned on a focal plane of the relay amplifying lens and symmetrically arranged with respect to the light axis, and further comprising: a Raman spectrum collection lens positioned in a transmission direction of the dichroic beam splitter and configured to detect Raman spectrum, and a Raman spectrum detecting system positioned at a focal point of the Raman spectrum collection lens; a laser-induced breakdown spectrum collection lens and a laser-induced breakdown spectrum detecting system that are positioned in a. transmission direction of the beam splitter and configured to detect laser-induced breakdown spectrum, and an ionization sample suction pipe used for desorption ionization of plasma plume composition by a focusing spot of the D-type lighting collection lens and a mass spectrum detecting system, wherein the incident optical axis and the collecting optical axis have an included angle of 2α therebetween and are symmetrical with respect to a measurement surface normal.

5. The divided-aperture laser differential confocal LIBS and Raman spectrum-mass spectrum microscopic imaging device according to claim 4, wherein: the compression focusing spot system may be substituted by a vector beam generating system configured to generate a vector beam and a pupil filter that are arranged along the direction of an incident optical axis.

6. The divided-aperture laser differential confocal LIBS and Raman spectrum-mass spectrum microscopic imaging device according to claim 4, wherein: the D-type lighting collection lens may be substituted by a circular lighting collection lens.

7. The divided-aperture laser differential confocal LIBS and Raman spectrum-mass spectrum microscopic imaging device according to claim 4, wherein: the first light intensity point detector and the second light intensity point detector may be substituted by a CCD detector.
